(19) United States
(12) Patent Application Publication
(10) Pub. No.: US 2026/0184078 A1
(43) Pub. Date: Jul. 2, 2026

(54) LIQUID EJECTING UNIT, AND METHOD OF MANUFACTURING LIQUID EJECTING UNIT

(71) Applicant: BROTHER KOGYO KABUSHIKI KAISHA, Nagoya (JP)

(72) Inventor: Kosuke TORIKAI, Nagoya (JP)

(73) Assignee: BROTHER KOGYO KABUSHIKI KAISHA, Nagoya (JP)

(21) Appl. No.: 19/422,779

(22) Filed: Dec. 17, 2025

(30) Foreign Application Priority Data
Dec. 27, 2024 (JP) 2024-231664

(51) Int. Cl. B41J 2/17; B41J 2/14; B41J 2/16; B41J 29/377

(52) U.S. Cl. CPC B41J 2/1707; B41J 2/14233; B41J 2/161; B41J 29/377; B41J 2002/14258; B41J 2002/14419; B41J 2202/08; B41J 2202/19

(57) ABSTRACT

A liquid ejecting unit includes a head; and a heating assembly. The heating assembly includes: a main body having a channel configured to flow liquid through the channel, the channel being disposed inside the main body, the liquid being liquid to be supplied to the head; a holder including a facing portion facing the main body in a facing direction and a connecter connecting the main body and the facing portion; a heater configured to apply heat to the main body; a main metal plate positioned between the heater and the facing portion in the facing direction; and a sub-metal plate positioned between the main metal plate and the facing portion in the facing direction, the sub-metal plate pressing the heater toward the main body via the main metal plate.

### SPECIFICATION

### REFERENCE TO RELATED APPLICATIONS

This application claims priority from Japanese Patent Application No. 2024-231664 filed on December 27, 2024. The entire content of the priority application is incorporated herein by reference.

### BACKGROUND ART

A known image recording apparatus ejects liquid such as ink onto a medium such as a sheet, via a liquid ejecting head. Regarding such an image recording apparatus, a technique in which ink to be ejected from the liquid ejecting head is heated in a head system including the liquid ejecting head is known.

### SUMMARY

In some of the head systems such as describe above, an operation of attaching a heater module to a channel block of a preheating channel is troublesome. This is because the attaching operation is performed against the frictional force generated between the channel block and the heater module.

The present disclosure aims to provide a liquid ejecting unit in which the trouble required for an assembly operation is reduced, and a method of manufacturing a liquid ejecting unit with which the trouble required for the assembly operation can be reduced.

A first aspect of the present disclosure is a liquid ejecting unit including: a head; and a heating assembly. The heating assembly includes: a main body having a channel configured to flow liquid through the channel, the channel being disposed inside the main body, the liquid being liquid to be supplied to the head; a holder including a facing portion facing the main body in a facing direction and a connecter connecting the main body and the facing portion; a heater configured to apply heat to the main body; a main metal plate positioned between the heater and the facing portion in the facing direction; and a sub-metal plate positioned between the main metal plate and the facing portion in the facing direction, the sub-metal plate pressing the heater toward the main body via the main metal plate.

A second aspect of the present disclosure is a method of manufacturing a liquid ejecting unit, the liquid ejecting unit including: a head; and a heating assembly. The heating assembly includes: a main body having a channel configured to flow liquid through the channel, the channel being disposed inside the main body, the liquid being liquid to be supplied to the head; a holder including a facing portion facing the main body in a facing direction and a connecter connecting the main body and the facing portion; a heater configured to apply heat to the main body; a main metal plate positioned between the heater and the facing portion in the facing direction; and a sub-metal plate positioned between the main metal plate and the facing portion in the facing direction, the sub-metal plate pressing the heater toward the main body via the main metal plate. The method including: inserting the heater and the main metal plate into a space between the main body and the facing portion along a first direction; and fitting the sub-metal plate into a space between the inserted main metal plate and the facing portion along a second direction intersecting the first direction.

According to the liquid ejecting unit and the method of manufacturing the liquid ejecting unit of the present disclosure, the trouble for the operation of assembling the liquid ejecting unit are reduced.

### BRIEF DESCRIPTION OF DRAWINGS

FIG. 1 is a diagram illustrating the schematic configuration of a printer.

FIG. 2 is a schematic perspective view of a head system.

FIG. 3 is a plan view in which a left wall of a first part of a casing is viewed from the outside (left).

FIG. 4 is a plan view of a heating assembly as viewed from the front.

FIG. 5 is a cross-sectional view along a line V-V of FIG. 4.

FIG. 6A is a perspective view of a channel part, and block bodies positioned at both ends of the channel part.

FIG. 6B is a perspective view of a heater module.

FIG. 6C is a perspective view of a fixing plate.

FIG. 7 is a view illustrating the disposition of an ink channel inside the heating assembly.

FIG. 8 is an exploded perspective view in which a top plate is separated from a sub-tank.

FIG. 9 is a bottom view of the sub-tank.

FIG. 10 is a perspective view of a head mechanism.

FIG. 11 is a plan view of a channel unit and an actuator.

FIG. 12 is a cross-sectional view along a line XII-XII of FIG. 11.

FIG. 13 is a schematic view of a first ink channel in a head system.

FIG. 14 is a schematic view of a second ink channel in the head system.

FIGS. 15A to 15D are diagrams describing the procedure of an operation of assembling the heating assembly. FIG. 15A illustrates a situation where the heater module is being inserted into a housing space of the channel part. FIG. 15B illustrates a situation where a fixing plate is being inserted into a space between the channel part and the heater module. FIG. 15C illustrates a situation where two fixing plates have been inserted into the space between the channel part and the heater module. FIG. 15D illustrates a state where the assembling of the heating assembly has been completed.

FIG. 16 is a cross-sectional view of a heating assembly, along a plane orthogonal to the longitudinal direction of the heating assembly.

### DESCRIPTION

### Embodiment

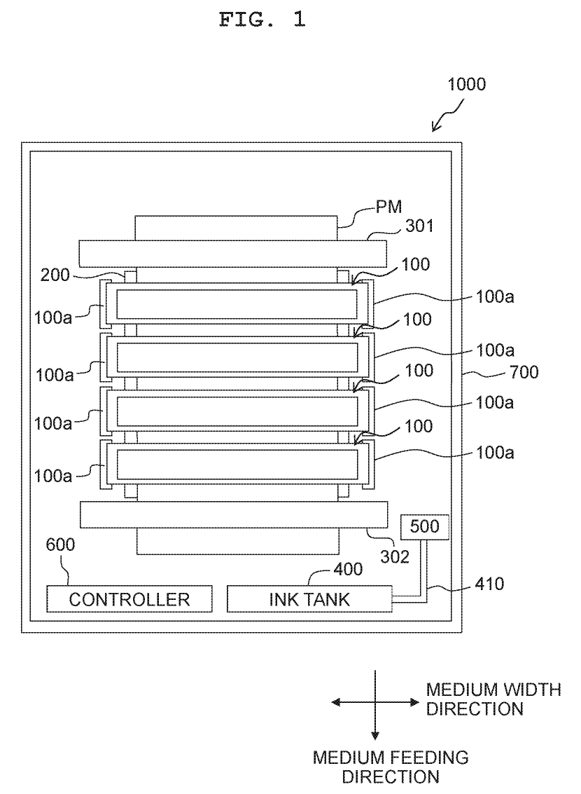

A head system 100 (an example of a "liquid ejecting unit") and a printer 1000, as an embodiment of the present disclosure, will be described with reference to FIG. 1 to FIG. 15.

### Printer 1000

As illustrated in FIG. 1, the printer 1000 mainly includes: four head systems 100, a platen 200, a pair of conveying rollers 301 and 302, an ink tank 400, a reservoir 500, a controller 600, and a casing 700 housing the above-described components.

Regarding the printer 1000, a direction in which the pair of conveying rollers 301 and 302 are aligned, that is, a direction in which a medium PM is conveyed during image formation will be referred to as a "medium feeding direction". Further, a direction extending in a horizontal plane and orthogonal to the medium feeding direction will be referred to as a "medium width direction".

Each of the four head systems 100 is a so-called line type head, and is supported by frames 100a at both end portions in the medium width direction of the head system 100. Eight frames 100a support the four head systems 100 so that a front-rear direction (to be described later) of each of the four head systems 100 matches the medium feeding direction of the printer 1000, and that nozzle surfaces 40n (to be described later) of the four head systems 100 face the upper surface of the platen 200.

In the present embodiment, each of the four head systems 100 is configured to eject two kinds of inks, among four mutually differing kinds of inks. These four kinds of inks are, for example, cyan ink, magenta ink, yellow ink, and black ink. The specific structure and function of each of the head system 100 will be described later.

The platen 200 is a plate member which supports the medium PM from an opposite side with respect to the head systems 100 (from below) in a case where the ink is ejected toward the medium PM from the head systems 100.

The pair of conveying rollers 301 and 302 are disposed, with the platen 200 being interposed between the pair of conveying rollers 301 and 302 in the medium feeding direction. The pair of conveying rollers 301 and 302 function as a conveying mechanism which feeds the medium PM in the medium feeding direction in a certain aspect in a case where the head system 100 forms an image on the medium PM.

The ink tank 400 is divided into four parts so that the tank 400 is capable of accommodating the four colors of inks. The four colors of inks are fed from the ink tank 400 to the reservoir 500 via a pipe channel 410. The reservoir 500 is also divided into four parts so that the reservoir 500 is capable of accommodating the four colors of inks. Each of the four colors of inks which has been fed to the reservoir 500 is circulated between the reservoir 500 and corresponding one of the head systems 100 via an unillustrated pipe channel and an unillustrated pump.

The controller 600 carries out overall control of each of parts included in the printer 1000 to cause each of the parts to perform, for example, the image formation on the medium PM. The controller 600 includes an FPGA (Field Programmable Gate Array), an EEPROM (Electrically Erasable Programmable Read-Only Memory), a RAM (Random Access Memory), and so on. Note that the controller 600 may include, for example, a CPU (Central Processing Unit) or an ASIC (Application Specific Integrated Circuit). The controller 600 is connected to an external device, such as a PC (not illustrated in the drawings), so that data can be communicated between the controller 600 and the external device, and the controller 600 controls each of the parts of the printer 1000 based on printing data transmitted from the external device.

### Head System 100

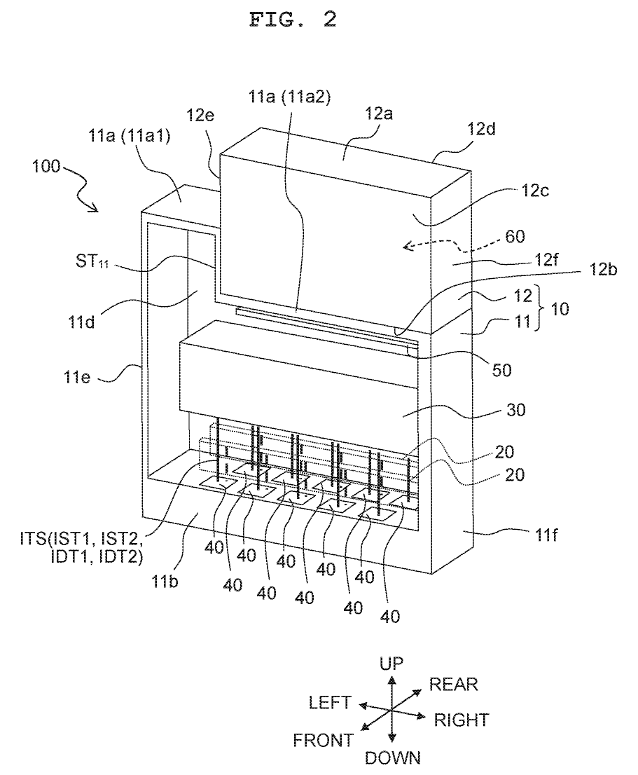

As illustrated in FIG. 2, each of the four head systems 100 mainly includes a casing 10, two heating assemblies 20, a sub-tank 30, ten head mechanisms 40, ten ink tube sets ITS, a relay board 50, and a control board part 60. Since the four head systems 100 have the same configuration as each other, one head system 100 of the four head systems 100 will be described in the following.

In the following description, a direction in which the ten head mechanisms 40 are disposed in a staggered (zigzag) pattern will be referred to as a width direction of the head system 100, and a direction in which the ten head mechanisms 40 and the sub-tank 30 are aligned will be referred to as an up-down direction. Further, a direction orthogonal to the width direction and the up-down direction will be referred to as the front-rear direction of the head system 100.

Regarding the front-rear direction, the near side and the far side of the sheet surface of FIG. 2 will be defined as the front and the rear in the front-rear direction. Regarding the width direction, the left and the right as viewed from the front in the front-rear direction will be defined as the left and the right in the width direction. Regarding the up-down direction, a side on which the sub-tank 30 is positioned with respect to the ten head mechanisms 40 will be defined as the upper side, and a side opposite to the upper side will be defined as the under side.

Note that in a state where the head system 100 is mounted on the printer 1000, the width direction of the head system 100 matches the medium width direction of the printer 1000, and the front-rear direction of the head system 100 matches the medium feeding direction of the printer 1000.

### Casing 10

The casing 10 may be formed, for example, of a metal. The casing 10 includes a first part 11, and a second part 12 which is detachable with respect to the first part 11.

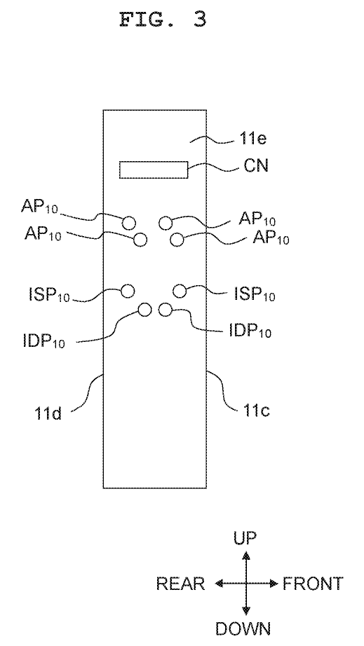

The first part 11 has a top plate 11a, a bottom portion 11b, a front wall 11c (see FIG. 3; the front wall 11c is omitted in the illustration of FIG. 2 so that the inside of the first part 11 can be illustrated), a rear wall 11d, a left wall 11e, and a right wall 11f. The top plate 11a and the bottom portion 11b have a rectangular shape which is long in the width direction in planar view. The top plate 11a has a step portion ST₁₁, and thus a first region 11a1 in the vicinity of a left end of the top plate 11a is positioned above a second region 11a2 in the vicinity of a right end of the top plate 11a. The front wall 11c and the rear wall 11d are each a flat plate extending along a plane including the width direction and the up-down direction, and the left wall 11e and the right wall 11f are each a flat plate extending along a plane including the front-rear direction and the up-down direction. The left wall 11e and the right wall 11f are orthogonal to the front wall 11c and rear wall 11d.

As illustrated in FIG. 3, an electrical connector CN is disposed at an upper portion of the left wall 11e, and four air flow ports AP₁₀ are disposed below the electrical connector CN. Two ink supply ports ISP₁₀ and two ink discharge ports IDP₁₀ are disposed below the four air flow ports AP₁₀. Note that the electrical connector CN, the four air flow ports AP₁₀, the two ink supply ports ISP₁₀, and the two ink discharge ports IDP₁₀ are omitted in the illustration of FIG. 2.

As described above, since the electrical connector CN is disposed above the ink supply ports ISP₁₀ and the ink discharge ports IDP₁₀, an electrical short circuit can be prevented from occurring in the electrical connector CN, even in a case where the ink has leaked from the ink supply ports ISP₁₀ and the ink discharge ports IDP₁₀.

As illustrated in FIG. 2, the second part 12 has a top plate 12a, a bottom plate 12b, a front wall 12c, a rear wall 12d, a left wall 12e, and a right wall 12f. In a state where the second part 12 is attached to the first part 11, the bottom plate 12b of the second part 12 contacts a region, of the top plate 11a of the first part 11, in the vicinity of the right end.

### Heating Assembly 20

Each of the two heating assemblies 20 is configured to feed the ink supplied to the head system 100 via the ink supply port ISP₁₀ of the casing 10 to the sub-tank 30 while raising the temperature of the ink.

As illustrated in FIG. 2, the two heating assemblies 20 are disposed side by side in the front-rear direction in the vicinity of the bottom portion 11b of the first part 11 of the casing 10. Each of the two heating assemblies 20 has a long shape, and each of which is disposed so that the longer direction of the heating assembly 20 matches the width direction of the head system 100 and the shorter direction of the heating assembly 20 matches the up-down direction of the head system 100. Further, each of the two heating assemblies 20 is positioned downstream of the ink supply port ISP₁₀ and upstream of the sub-tank 30 in a flow direction of the ink.

In FIG. 2, the two heating assemblies 20 are illustrated with dotted lines so that a structure positioned behind the two heating assemblies 20 can be viewed. The rear surface of one heating assembly 20, of the two heating assemblies 20, positioned on the front faces five ink tube sets ITS, of the ten ink tube sets ITS, positioned on the front. The rear surface of the other heating assembly 20, of the two heating assemblies 20, positioned on the rear faces five ink tube sets ITS, of the ten ink tube sets ITS, positioned on the rear.

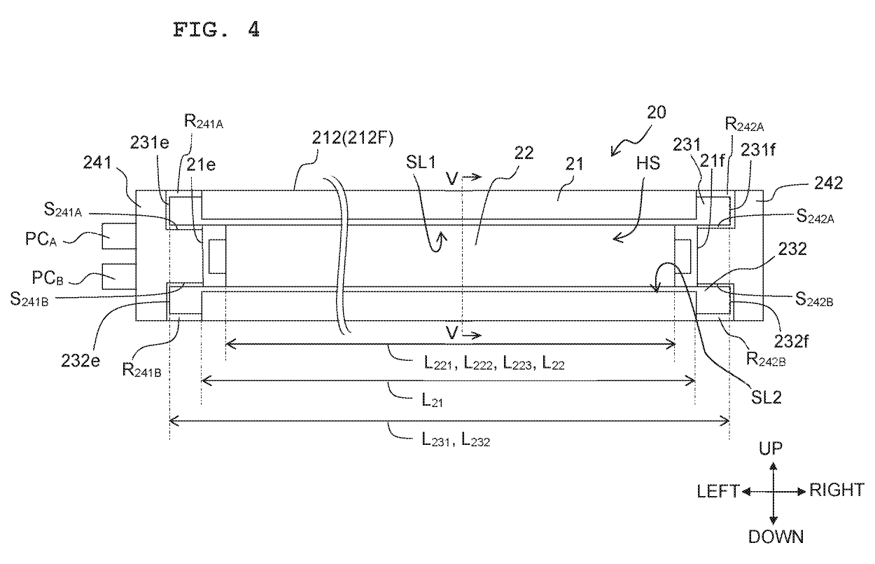

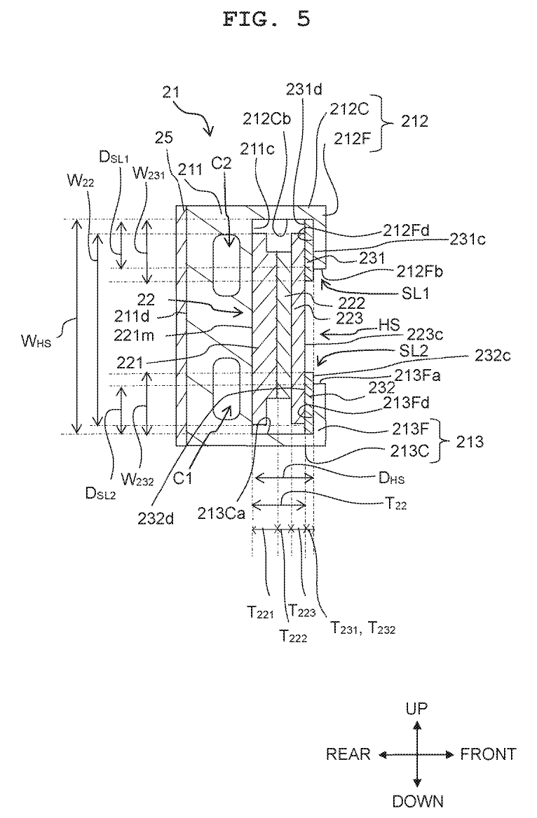

The two heating assemblies 20 have the same structure as each other. As illustrated in FIG. 4 and FIG. 5, each of the two heating assemblies 20 has a channel part 21 in which an ink channel is defined inside the channel part 21, a heater module 22 which applies heat to the channel part 21, fixing plates 231 and 232 (each an example of a "sub metal plate") which fix the heater module 22 relative to the channel part 21, block bodies 241 and 242, and a radiation sheet 25.

The channel part 21 is a member configured to cause the ink to flow along a channel defined inside the channel part 21 while applying the heat from the heater module 22 to the ink. As illustrated in FIG. 4, the channel part 21 is a long member of which longer direction is the width direction of the head system 100 and of which shorter direction is the up-down direction of the head system 100. The dimension in the longer direction of the channel part 21 is defined as length L₂₁. The channel part 21 is preferably formed of a material having a high thermal conductivity, and may be formed of a metal such as aluminum, for example.

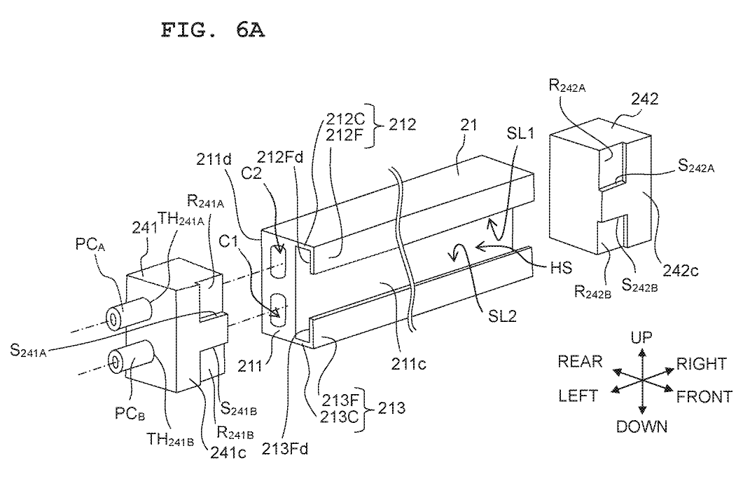

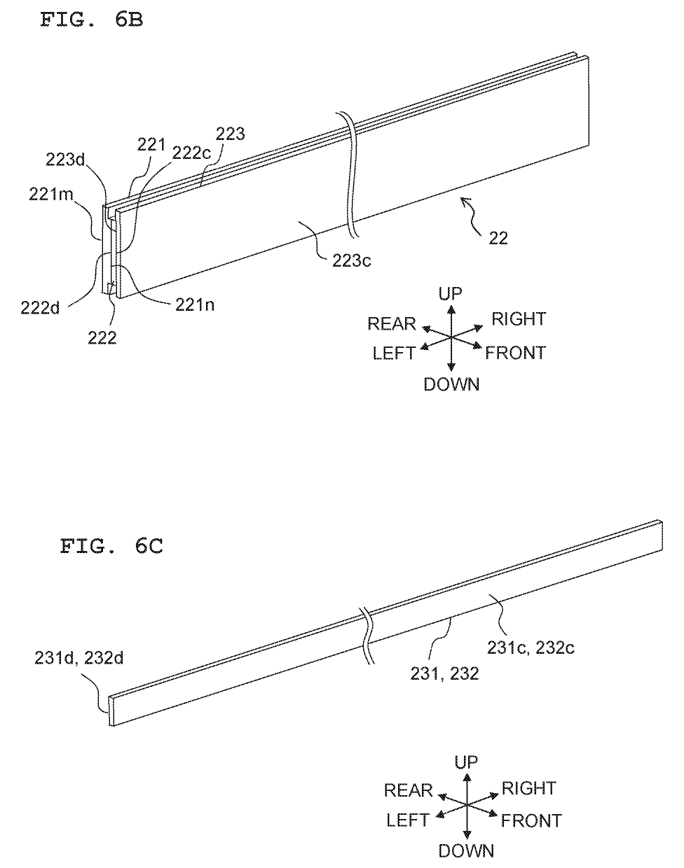

As illustrated in FIG. 6A, the channel part 21 has: a main body portion (main body) 211; and holding portions (holders) 212 and 213 formed integrally with the main body portion 211.

The main body portion 211 is rectangular bar-shaped. The main body portion 211 has a front surface 211c and a rear surface 211d each of which extends along a plane orthogonal to the front-rear direction of the head system 100.

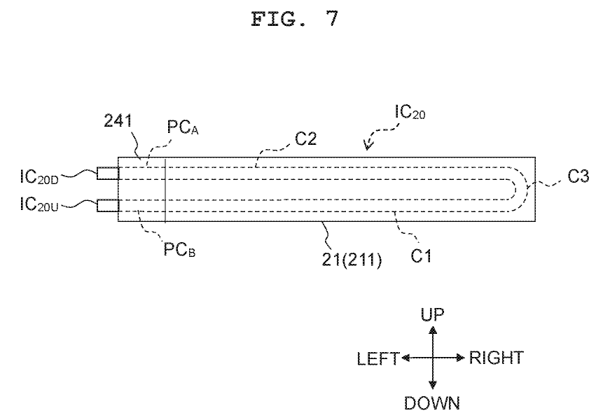

As illustrated in FIG. 7, a first channel C1, a second channel C2, and a third channel C3 are defined inside the main body portion 211. The first channel C1 is a linear channel extending in the longer direction of the channel part 21. The second channel C2 is a linear channel positioned above the first channel C1 and extending parallel to the first channel C1. The third channel C3 is a U-shaped channel and connects the right end of the first channel C1 and the right end of the second channel C2.

The cross-sectional shapes of the first channel C1, second channel C2, and third channel C3 are each elliptic (see FIG. 5 and FIG. 6A). In a case where the cross-sectional shapes of the first channel C1 to third channel C3 are made elliptic, the contact area between the ink flowing through the first channel C1 to third channel C3 and the main body portion 211 can be easily made larger than in a case where the cross-sectional shapes of the first channel C1 to third channel C3 are each made a perfect circle. Therefore, the heat from the heater module 22 can be applied to the ink efficiently.

As depicted in FIG. 6A, the holding portion 212 is an angle bar-like portion projecting forward from the upper edge of the front surface 211c of the main body portion 211 and bending downward. The holding portion 212 has a facing portion 212F facing the main body portion 211 in the front-rear direction (an example of a "facing direction"), and a connecting portion (connector) 212C extending in the front-rear direction and connecting the main body portion 211 and the facing portion 212F.

The facing portion 212F is a plate portion extending in a plane orthogonal to the front-rear direction. A rear surface 212Fd of the facing portion 212F faces the front surface 211c of the main body portion 211 in the front-rear direction. The rear surface 212Fd and the front surface 211c both extend in the plane orthogonal to the front-rear direction, and are parallel to each other. The connecting portion 212C is a plate-shaped portion extending in a plane orthogonal to the up-down direction.

As illustrated in FIG. 6A, the holding portion 213 is an angle bar-like portion projecting forward from the lower edge of the front surface 211c of the main body portion 211 and bending upward. The holding portion 213 includes a facing portion 213F facing the main body portion 211 in the front-rear direction and a connecting portion 213C extending in the front-rear direction and connecting the main body portion 211 and the facing portion 213F.

The facing portion 213F is a plate portion extending in the plane orthogonal to the front-rear direction. A rear surface 213Fd of the facing portion 213F faces the front surface 211c of the main body portion 211 in the front-rear direction. The rear surface 213Fd and the front surface 211c both extend in the plane orthogonal to the front-rear direction and are parallel to each other. Further, the rear surface 213Fd is positioned on the same plane as the rear surface 212Fd of the facing portion 212F of the holding portion 212. That is, the rear surface 212Fd is flush with the rear surface 213Fd. The connecting portion 213C is a plate portion extending in the plane orthogonal to the up-down direction.

The channel part 21 defines a housing space HS, which houses the heater module 22, with the front surface 211c, the holding portion 212 and the holding portion 213 of the main body portion 211. The housing space HS includes a groove SL1 defined by the main body portion 211 and the holding portion 212, and a groove SL2 defined by the main body portion 211 and the holding portion 213. The groove SL1 is a slot which extends in the longer direction of the channel part 21 and which is open downward. The groove SL2 is a slot which extends in the longer direction of channel part 21 and which is open upward.

The dimensions of the housing space HS, the groove SL1 and the groove SL2 in the longer direction of channel part 21 (i.e., the width direction of the head system 100) are each equal to the length L₂₁ of the channel part 21.

A distance between the front surface 211c and the rear surface 212Fd or the rear surface 213Fd is defined as a depth D_{HS} of the housing space HS (FIG. 5). A distance from a lower surface 212Cb of the connecting portion 212C to an upper surface 213Ca of the connecting portion 213C is defined as a width W_{HS} of the housing space HS. A distance from a lower end portion 212Fb to the lower surface 212Cb of the connecting portion 212C is defined as a depth D_{SL1} of the groove SL1. A distance from an upper end portion 213Fa of the facing portion 213F to the upper surface 213Ca of the connecting portion 213C is defined as a depth D_{SL2} of the groove SL2. The depth D_{SL1} and the depth D_{SL2} are equal to each other.

The heater module 22 is a module configured to generate the heat to be applied to the channel part 21. As illustrated in FIG. 4 and FIG. 5, the heater module 22 is positioned inside the housing space HS of the channel part 21.

As illustrated in FIG. 6B, the heater module 22 has: a heater 221; a heat-dissipating sheet 222; and a metal plate 223 (an example of a "main metal plate").

The heater 221 has a function to apply the heat to the main body portion 211 of the channel part 21. The heater 221 is a long planar (belt-like) heater of which longer direction is the width direction of the head system 100, and of which shorter direction is the up-down direction of the head system 100. The heater 221 has a heat-generating surface 221m and an opposite surface 221n (FIG. 6B) opposite to the heat-generating surface 221m. The entire region of the heat-generating surface 221m of the heater 221 is in contact with the front surface 211c of the main body portion 211 of the channel part 21 (FIG. 5).

The heat-dissipating sheet 222 has a function to release the excess heat generated in the heater 221 to the outside of the heating assembly 20. The heat-dissipating sheet 222 may be formed of an elastic material having a high thermal conductivity, such as silicone, for example.

The heat-dissipating sheet 222 is a long planar (belt-like) member of which longer direction is the width direction of the head system 100, and of which shorter direction is the up-down direction of the head system 100. The entire region of a rear surface 222d of the heat-dissipating sheet 222 is in contact with the opposite surface 221n of the heater 221.

The metal plate 223 is a member configured to dissipate the excess heat transferred from the heater 221 to the heat-dissipating sheet 222 to the outside of the heating assembly 20. The metal plate 223 may be formed of a metal having a high thermal conductivity, such as aluminum as an example.

The metal plate 223 is a long flat plate of which longer direction is the width direction of the head system 100 and of which shorter direction is the up-down direction of the head system 100. The metal plate 223 has a flat front surface 223c and a flat rear surface 223d. The front surface 222c of the heat-dissipating sheet 222 is in contact with a center portion in the up-down direction of the rear surface 223d.

In a case where the dimension in the longer direction of the heater 221 is defined as a length L₂₂₁ (FIG. 4), the dimension in the longer direction of the heat-dissipating sheet 222 is defined as a length L₂₂₂, and the dimension in the longer direction of the metal plate 223 is defined as a length L₂₂₃, the length L₂₂₁, the length L₂₂₂, and the length L₂₂₃ are equal to one another and are each smaller than the length L₂₁ of the channel part 21. In the present embodiment, each of the length L₂₂₁, the length L₂₂₂, and the length L₂₂₃ is also equal to the length L₂₂ of the heater module 22.

In a case where the dimension in the thickness direction of the heater 221 (the front-rear direction of the head system 100) is defined as a thickness T₂₂₁ (FIG. 5), the dimension in the thickness direction of the heat-dissipating sheet 222 is defined as a thickness T₂₂₂, and the dimension in the thickness direction of the metal plate 223 is defined as a thickness T₂₂₃, a total value of thicknesses T₂₂₁, T₂₂₂, and T₂₂₃ (i.e., a thickness T₂₂ of the heater module 22) is smaller than the depth D_{HS} of the housing space HS.

In a case where the dimension in the shorter direction of the heater module 22 (the up-down direction of the head system 100) is defined as a width W₂₂ (FIG. 5), the width W₂₂ is smaller than the width W_{HS} of the housing space HS. Note that the width W₂₂ of the heater module 22 is equal to the dimension in the shorter direction of one of the heater 221, the heat-dissipating sheet 222 and the metal plate 223 of which dimension in the shorter direction is the largest. In the present embodiment, the width W₂₂ of the heater module 22 is equal to the dimensions in the shorter dimensions of the heater 221 and the metal plate 223. In a state where the heater module 22 is fixed relative to the channel part 21, a clearance exists between the upper end portion of the heater module 22 and the lower surface 212Cb of the connecting portion 212C, and between the lower end portion of the heater module 22 and the upper surface 213Ca of the connecting portion 213C.

The fixing plates 231 and 232 fix the heater module 22 relative to the channel part 21 and have a function of causing the excess heat transferred from the heater 221 to the metal plate 223 via the heat-dissipating sheet 222 to escape from the heating assembly 20 to the outside. The fixing plates 231 and 232 may be made of a metal having a high thermal conductivity, such as aluminum as an example.

The fixing plate 231 and the fixing plate 232 have the same shape as each other. As illustrated in FIG. 6C, each of the fixing plates 231 and 232 is a long flat plate of which longer direction is the width direction of the head system 100 and of which shorter direction is the up-down direction of the head system 100. The fixing plate 231 has a flat front surface 231c and a flat rear surface 231d, and the fixing plate 232 has a flat front surface 232c and a flat rear surface 232d.

In a case where the dimension in the longer direction of the fixing plate 231 is defined as a length L₂₃₁ (FIG. 4) and the dimension in the longer direction of the fixing plate 232 is defined as a length L₂₃₂, the length L₂₃₁ and the length L₂₃₂ are equal to each other and larger than the length L₂₁ of the channel part 21. In a case where the dimension in the shorter direction of the fixing plate 231 is defined as a width W₂₃₁(FIG. 5) and the dimension in the shorter direction of the fixing plate 232 is defined as a width W₂₃₂, the width W₂₃₁ and the width W₂₃₂ are equal to each other and are each larger than the depths D_{SL1} and D_{LS2} of the grooves D_{SL1} and D_{SL2}.

A major portion in the longer direction of the fixing plate 231 is positioned inside the groove SL1. A region in the vicinity of a left end portion 231e of the fixing plate 231 protrudes to the left of a left end portion 21e of the channel part 21 and is positioned inside a recessed portion R_{241A} (to be described later) of the block body 241. A region, of the fixing plate 231, in the vicinity of a right end portion 231f protrudes to the right of the right end portion 21f of the channel part 21 and is positioned inside a recessed portion R_{242A} (to be described later) of the block body 242.

Similarly to the fixing plate 231, a major portion in the longer direction of the fixing plate 232 is positioned inside the groove SL2. A region in the vicinity of a left end portion 232e of the fixing plate 232 protrudes to the left of the left end portion 21e of the channel part 21 and is positioned inside a recessed portion R_{241B} (to be described later) of the block body 241. A region, of the fixing plate 232, in the vicinity of a right end portion 232f protrudes to the right of the right end portion 21f of the channel part 21 and is positioned inside a recessed portion R_{242B} (to be described later) of the block body 242.

The fixing plate 231 and the fixing plate 232 are apart from each other in the up-down direction. That is, a clearance exists between the lower edge of the fixing plate 231 and the upper edge of the fixing plate 232.

In the width direction of the head system 100, each of the fixing plates 231 and 232 is present in the entire area of a region in which the heater module 22 (i.e., the heater 221, the heat-dissipating sheet 222, and the metal plate 223) is present.

As illustrated in FIG. 5, at the inside of the groove SL1, a region, of the rear surface 231d of the fixing plate 231, which is different from a region in the vicinity of the upper edge of the rear surface 231d of the fixing plate 231 is in contact with a region in the vicinity of the upper edge of the front surface 223c of the metal plate 223. Further, since the width W₂₃₁ of the fixing plate 231 is larger than the depth D_{SL1} of the groove SL1, a region, of the front surface 231c of the fixing plate 231, which is different from the region in the vicinity of the lower edge of the front surface 231c of the fixing plate 231, is in contact with the entire area of the rear surface 212Fd of the facing portion 212F of the holding portion 212.

Similarly, at the inside of the groove SL2, a region, of the rear surface 232d of the fixing plate 232, which is different from a region in the vicinity of the lower edge of the rear surface 232d of the fixing plate 232 is in contact with a region in the vicinity of the lower edge of the front surface 223c of the metal plate 223. Further, since the width W₂₃₂ of the fixing plate 232 is larger than the depth D_{SL2} of the groove SL2, a region, of the front surface 232c of the fixing plate 232, which is different from the region in the vicinity of the upper edge of the front surface 232c of the fixing plate 232, is in contact with the entire area of the rear surface 231Fd of the facing portion 213F of the holding portion 213.

In a case where the dimension in the thickness direction of the fixing plate 231 is defined as a thickness T₂₃₁(FIG. 5) and the dimension in the thickness direction of the fixing plate 232 is defined as a thickness T₂₃₂, the thickness T₂₃₁ and the thickness T₂₃₂ are equal to each other. Further, the total value of the thickness T₂₂ of the heater module 22 and the thickness T₂₃₁ of the fixing plate 231 (or the thickness T₂₃₂ of the fixing plate 232) is greater than the depth D_{HS} of the housing space HS in a state that the heater module 22 and fixing plates 231 and 232 are separated from the channel part 21 and no force is applied from the surroundings. On the other hand, the total value of thickness T₂₂ and the thickness T₂₃₁ (or the thickness T₂₃₂) is equal to the depth D_{HS} of the housing space HS in a state where the heater module 22 and the fixing plates 231 and 232 are housed in the housing space HS in the channel part 21. The reason for the above is that the heater module 22 and the fixing plates 231 and 232 are housed in the housing space HS in a state where the heater module 22 (specifically, for example, the heat-dissipating sheet 222) is compressed in the thickness direction. Therefore, in the state that the heater module 22 and the fixing plates 231 and 232 are housed in the housing space HS, the fixing plates 231 and 232 press the heater module 22 toward the main body portion 211 of the channel part 21, and thus the heater module 22 is fixed relative to the channel part 21.

The block body 241 is attached to the left end portion 21e of the channel part 21. As illustrated in FIG. 6A, the block body 241 has a through hole TH_{241A} and a through hole TH_{241B} extending through the inside of the block body 241, and a recessed portion R_{241A} and a recessed portion R_{241B} positioned in the front surface 241c of the block body 241. The through hole TH_{241A} and the through hole TH_{241B} are disposed side by side in the up-down direction.

Pipe channels PC_{A} and PC_{B} are inserted, respectively, into the through holes TH_{241A} and TH_{241B}. As illustrated in FIG. 7, the pipe channels PC_{A} and PC_{B} are fluidly connected to the first channel C1 to the third channel C3 of the channel part 21, and construct an ink channel IC₂₀, together with the first channel C1 to the third channel C3. An end portion of the pipe channel PC_{B} is an upstream end IC_{20U} of the ink channel IC₂₀, and an end portion of the pipe channel PC_{A} is a downstream end IC_{20D} of the ink channel IC₂₀.

As illustrated in FIG. 4, the region in the vicinity of the left end portion 231e of the fixing plate 231 positioned inside the recessed portion R_{241A} is restricted from moving downward by the upward-facing surface S_{241A} defining the recessed portion R_{241A}. Similarly, the region in the vicinity of the left end portion 232e of the fixing plate 232 positioned inside the recessed portion R_{241B} is restricted from moving upward by the downward-facing surface S_{241B} defining the recessed portion R_{241B}.

The block body 242 is attached to the right end portion 21f of the channel part 21. As illustrated in FIG. 6A, the block body 242 has a recessed portion R_{242A} and a recessed portion R_{242B} which are positioned in the front surface 242c of the block body 242.

As illustrated in FIG. 4, the region, in the vicinity of the right end portion 231f of the fixing plate 231 positioned inside the recessed portion R_{242A}, is restricted from moving downward by an upward-facing surface S_{242A} defining the recessed portion R_{242A}. Similarly, the region, in the vicinity of the right end portion 232f of the fixing plate 232 positioned inside the recessed portion R_{242B}, is restricted from moving upward by a downward-facing surface S_{242B} defining the recessed portion R_{242B}.

The radiation sheet 25 is disposed to efficiently radiate the heat from the channel part 21 to the outside. As illustrated in FIG. 5, the radiation sheet 25 is adhered to the rear surface 211d of the main body portion 211 of the channel part 21. The radiation sheet 25 may be adhered to a region excluding a region in the vicinity of the lower edge of the rear surface 211d and excluding a region in the vicinity of the both end portions in the longer direction of the rear surface 211d. The radiation sheet 25 may be a sheet formed of a material having a higher emissivity than the emissivity of the channel part 21, such as a carbon sheet, for example.

The heat radiated from the radiation sheet 25 heats the ink flowing through the ink tube sets ITS which extend in a location facing the radiation sheet 25.

### Sub-Tank 30

The sub-tank 30 receives the ink which has been heated in the heating assembly 20, and stores the heated ink. The sub-tank 30 also heats the stored ink. The ink stored in the sub-tank 30 is distributed to each of the plurality of head mechanisms 40.

As illustrated in FIG. 2, the sub-tank 30 is positioned above the two heating assemblies 20. The sub-tank 30 has a long shape and is positioned so that the longer direction of the sub-tank 30 matches with the width direction of the head system 100. Further, the sub-tank 30 is positioned downstream of the two heating assemblies 20 and upstream of the plurality of head mechanisms 40 in the flow direction of the ink.

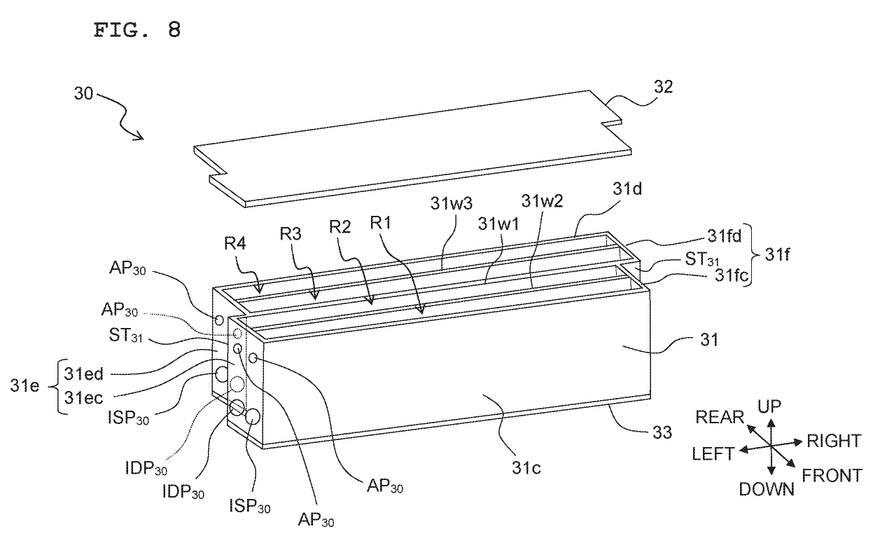

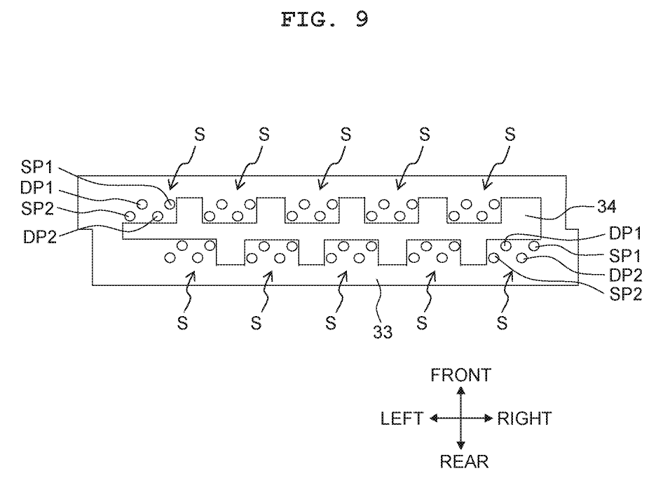

As illustrated in FIG. 8 and FIG. 9, the sub-tank 30 is constructed of a main body part 31, a top plate 32, and a bottom plate 33. The lower surface of the bottom plate 33 has a heater 34 (FIG. 9) which is adhered to the lower surface.

The main body part 31 is formed of resin, as an example.

The main body part 31 has a front wall 31c and a rear wall 31d extending along a plane orthogonal to the front-rear direction of the head system 100, and has a left wall 31e and a right wall 31f extending along a plane orthogonal to the width direction of the head system 100.

Each of the left wall 31e and the right wall 31f has a step portion ST₃₁ in a central portion in the front-rear direction. In the left wall 31e and the right wall 31f, front portions 31ec and 31fc positioned in front of the step portion ST₃₁ are disposed to the left of rear portions 31ed and 31fd which are positioned behind the step portion ST₃₁.

In the front portion 31ec, an ink supply port ISP₃₀ is defined in a frontward portion in the vicinity of the lower edge of the front portion 31ec, and an ink discharge port IDP₃₀ is defined behind the ink supply port ISP₃₀. Further, in the front portion 31ec, two air flow ports AP₃₀ are defined side by side in the front-rear direction in a portion in the vicinity of the upper edge of the front portion 30ec. In the rear portion 31ed, an ink supply port ISP₃₀ is defined in a rearward portion in the vicinity of the lower edge of the rear portion 31ed, and an ink discharge port IDP₃₀ is defined in front of the ink supply port ISP₃₀. Further, two air flow ports AP₃₀ are defined side by side in the front-rear direction at a location in the vicinity of the upper edge of the rear portion 30ed.

The main body part 31 further has a first separation wall 31w1, a second separation wall 31w2, and a third separation wall 31w3 which are parallel to the front wall 31c and the rear wall 31d and which extend between the left wall 31e and the right wall 31f.

The first separation wall 31w1 is located at the same position as the step portion ST₃₁ of each of the left wall 31e and the right wall 31f in the front-rear direction. The second separation wall 31w2 is located, in the front-rear direction, between the ink supply port ISP₃₀ and the ink discharge port IDP₃₀ and between the two air flow ports AP₃₀ of the front portion 31ec of the left wall 31e. The third separation wall 31w3 is located, in the front-rear direction, between the ink supply port ISP₃₀ and the ink discharge port IDP₃₀ and between the two air flow ports AP₃₀ of the rear portion 31ed of the left wall 31e.

The top plate 32 is a flat plate made of metal, as an example. The shape of the top plate 32 in planar view is the same as the shape of the contour of the main body part 31 as viewed from above. The top plate 32 is fixed relative to an upper end portion of the main body part 31, with an unillustrated sealing rubber being interposed between the top plate 32 and the upper end portion.

The bottom plate 33 is a flat plate made of metal (such as aluminum, as an example). The shape of the bottom plate 33in planar view is the same as the shape of the contour of the main body part 31 as viewed from above.

As illustrated in FIG. 9, ten ink flow port sets S are positioned in the lower surface of the bottom plate 33. Each of the ten ink flow port sets S includes a first ink supply port SP1, a second ink supply port SP2, a first ink discharge port DP1, and a second ink discharge port DP2.

The ten ink flow port sets S are disposed in a staggered (zigzag) pattern along the width direction of the head system 100. Further, in each of the ink flow port sets S, the first ink supply port SP1, the second ink supply port SP2, the first ink discharge port DP1, and the second ink discharge port DP2 are disposed in a staggered (zigzag) pattern along the width direction.

The bottom plate 33 is fixed to a lower end portion of the main body part 31, with an unillustrated sealing rubber being interposed between the lower end portion and the bottom plate 33.

As illustrated in FIG. 8, the main body part 31, the top plate 32 and the bottom plate 33 define, in order from the front, a first reservoir R1, a second reservoir R2, a third reservoir R3, and a fourth reservoir R4 inside the sub-tank 30.

A distribution channel (not illustrated in the drawings) disposed in the vicinity of the lower end portion of the main body part 31 communicates the first reservoir R1 with the first ink supply port SP1 of each of the ink flow port sets S. Further, the distribution channel communicates the second reservoir R2 with the first ink discharge port DP1 of each of the ink flow port sets S. The distribution channel communicates the third reservoir R3 with the second ink discharge port DP2 of each of the ink flow port sets S. The distribution channel communicates the fourth reservoir R4 with the second ink supply port SP2 of each of the ink flow port sets S.

The heater 34 applies the heat to the ink stored in each of the first reservoir R1 to the fourth reservoir R4. The heater 34 is a planar heater similar to the heater 221 of the heating assembly 20, and is positioned on the lower surface of the bottom plate 33 (FIG. 9).

In the present embodiment, the heater 34 is adhered to the bottom surface of the bottom plate 33 so that the heater 34 is positioned between the ink flow port sets S in the front-rear direction and the width direction of the head system 100. The heat generated in the heater 34 is applied to the ink in the first to fourth reservoirs R1 to R4 via the bottom plate 33.

Each of the four air flow ports AP₃₀ in the left wall 31e is connected to a corresponding one of the four air flow ports AP₁₀ of the casing 10, via an unillustrated pipe channel. The inside of each of the first to fourth reservoirs R1 to R4 is divided into a liquid phase in which the ink is stored and a gaseous phase which is positioned above the liquid phase and in which the air is present. In a case where the pressure of the gas phase in the first and fourth reservoirs R1 and R4 is made greater than the pressure of the gas phase in the second and third reservoirs R2 and R3 via the air flow ports AP₁₀, AP₃₀, the ink flows from first reservoir R1 and fourth reservoir R4 through the head mechanisms 40 and to second reservoir R2 and third reservoir R3.

### Head Mechanism 40

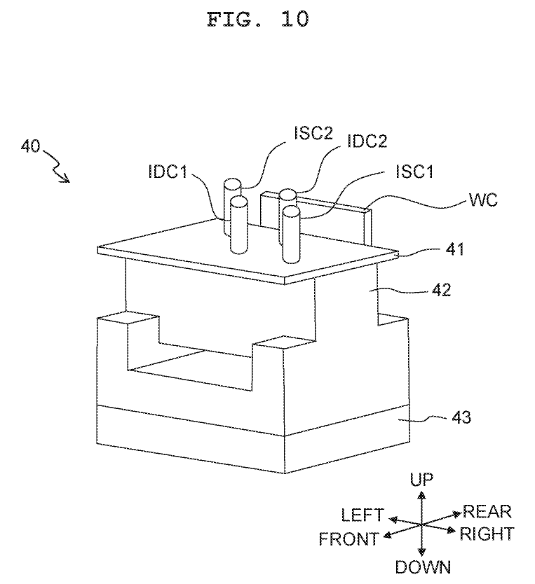

As illustrated in FIG. 10, each of the ten head mechanisms 40, which are of the same configuration as each other, has, in order from the top, a connection plate 41, a main body part 42, and a head 43. The head mechanism 40 further has a wiring connection portion WC extending in the up-down direction between a location above the connection plate 41 and the head 43.

The connection plate 41 includes ink supply tube connecting parts ISC1 and ISC2, and ink discharge tube connecting parts IDC1 and IDC2.

The main body part 42 is fixed to the lower surface of the connection plate 41. The main body part 42 has a channel which is defined inside the main body part 42 and via which the ink supplied to the ink supply tube connecting parts ISC1 and ISC2 is supplied to the head 43, and a channel which is defined inside the main body part 42 and via which the ink not ejected from the head 43 is returned to the ink discharge tube connecting parts IDC1 and IDC2.

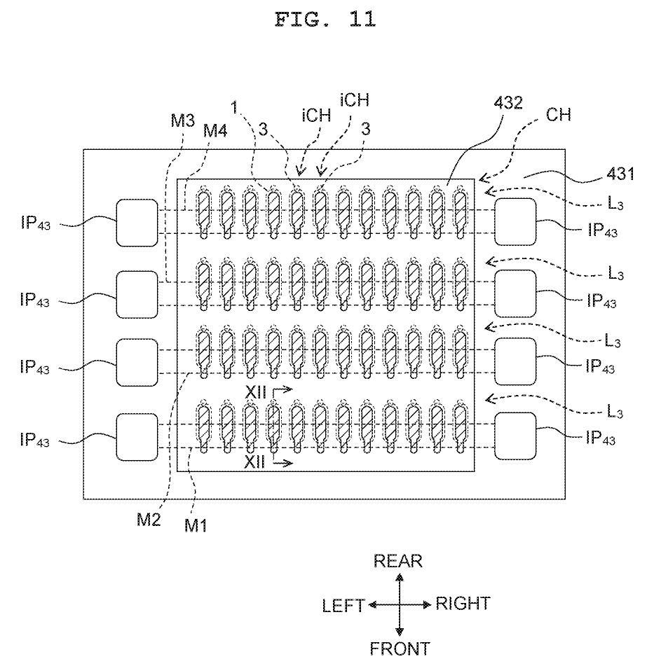

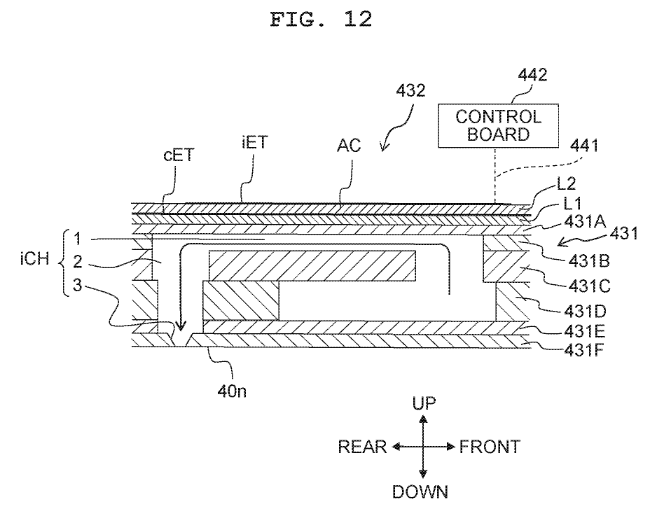

The head 43 is fixed to the lower surface of the main body part 42. The head 43 has a channel unit 431 and a piezoelectric actuator 432 (FIG. 11 and FIG. 12).

As illustrated in FIG. 12, the channel unit 431 is a laminated structure constructed of an ink sealing film 431A, plates 431B to 431E, and a nozzle plate 431F which are laminated in this order from the top. As illustrated in FIG. 11, the channel CH is defined inside the channel unit 431.

The channel CH includes eight ink flow ports IP₄₃, four manifold channels M1, M2, M3, and M4, and forty-eight individual channels iCH. Each of the four manifold channels M1 to M4 is a linear channel and communicates with corresponding two of the eight ink flow ports IP₄₃ at both end portions of each of the four manifold channels M1 to M4. Each of the four manifold channels M1 to M4 is connected to corresponding twelve individual channels iCH among the forty-eight individual channels iCH.

Each of the individual channels iCH includes a pressure chamber 1, a descender channel 2, and a nozzle 3, as illustrated in FIG. 12. The upper surface of the pressure chamber 1 is defined by the ink sealing film 431A. The descender channel 2 extends in the up-down direction from the pressure chamber 1 to the nozzle 3. The nozzle 3 is a minute opening via which the ink is ejected toward the medium PM, and is disposed in the nozzle plate 431F. The lower surface of the nozzle plate 431F, which is the lower surface of the head mechanism 40, is a nozzle surface 40n. A nozzle line L₃(FIG. 11) is positioned in the nozzle surface 40n along a direction in which each of the manifold channels M1 to M4 extends.

As illustrated in FIG. 12, the piezoelectric actuator 432 is constructed of a first piezoelectric layer L1 positioned on the upper surface of the channel unit 431, a second piezoelectric layer L2 positioned above the first piezoelectric layer L1, a common electrode cET interposed between the first piezoelectric layer L1 and the second piezoelectric layer L2, and a plurality of individual electrodes iET positioned on the upper surface of the second piezoelectric layer L2. The plurality of individual electrodes iET is positioned on the upper surface of the second piezoelectric layer L2 so that each of the plurality of individual electrodes iET is located above the pressure chamber 1 of a corresponding one of the plurality of individual channels iCH. Portions, of the second piezoelectric layer L2, each of which is interposed between the common electrode cET and a corresponding one of the plurality of individual electrodes iET are active portions AC polarized in the thickness direction.

Each of the plurality of individual electrodes iET of the piezoelectric actuator 432 is connected, via FPC (Flexible Printed Circuits, flexible printed circuit board) 441, to a control board 442 on which a driver IC is mounted. The control board 442 is positioned inside the main body part 42.

The wiring connection portion WC has a shape of a circuit board. An upper end portion of the wiring connection portion WC protrudes above the connection plate 41. The wiring connection portion WC is connected to a relay board 50 (to be described later) via an unillustrated flexible circuit board. A lower end portion of the wiring connection portion WC is connected to the control board 442.

Each of the head mechanisms 40 is fixed to the bottom portion 11b of the first part 11 (FIG. 2). In this state, the nozzle surface 40n of each of the head mechanisms 40 is exposed to an area below the casing 10. Further, the nozzle lines L₃ of the nozzle surface 40n extend along the width direction of the head system 100. The ten head mechanisms 40 are disposed in a staggered (zigzag) pattern along the width direction.

Each of the head mechanisms 40 is connected to the sub-tank 30 via a corresponding one of the ink tube sets ITS (FIG. 2). Each of the ink tube sets ITS includes two ink supply tubes IST1 and IST2 and two ink discharge tubes IDT1 and IDT2.

An upper end of each of the ink supply tubes IST1 is connected to the ink supply port SP1 of a corresponding one of the ink flow port sets S of the sub-tank 30. A lower end of each of the ink supply tubes IST1 is connected to the ink supply tube connecting part ISC1 of a corresponding one of the head mechanisms 40. The upper end of each of the ink supply tubes IST2 is connected to the ink supply port SP2 of a corresponding one of the ink flow port set S of the sub-tank 30. A lower end of each of the ink supply tubes IST2 is connected to the ink supply tube connecting part ISC2 of a corresponding one of the head mechanisms 40.

An upper end of each of the ink discharge tubes IDT1 is connected to the ink discharge port DP1 of a corresponding one of the ink flow port sets S of the sub-tank 30. A lower end of each of the ink discharge tubes IDT1 is connected to the ink discharge tube connecting part IDC1 of a corresponding one of the head mechanisms 40. An upper end of each of the ink discharge tubes IDT2 is connected to the ink discharge port DP2 of a corresponding one of the ink flow port sets S of the sub-tank 30. A lower end of each of the ink discharge tubes IDT2 is connected to the ink discharge tube connecting part IDC2 of a corresponding one of the head mechanisms 40.

The channels of the main body part 42 are configured so that the ink supplied to the ink supply tube connecting part ISC1 flows through the manifold channels M1 and M2, and that the ink discharged from the manifold channels M1 and M2 flows to the ink discharge tube connecting part IDC1. The channels in the main body part 42 are also configured so that the ink supplied to the ink supply tube connecting part ISC2 flows through the manifold channels M3 and M4, and that the ink discharged from the manifold channels M3 and M4 flows to the ink discharge tube connecting part IDC2. The channels of the main body part 42 may be configured so that ink flows in the same direction in all of the manifold channels M1 to M4, or so that a direction in which the ink flows in the manifold channels M1 and M3 is opposite to a direction in which the ink flows in the manifold channels M2 and M4.

### Relay Board 50

The relay board 50 is mainly configured to perform relaying between the control board part 60 (to be described later) and the control board 442 of the head mechanism 40. The relay board 50 is connected to the wiring connection portion WC of each of the ten head mechanisms 40 via an unillustrated flexible circuit board.

The relay board 50 is further connected to the electrical connector CN of the casing 10 via an unillustrated wiring, and distributes the power supplied from the electrical connector CN to, for example, the control board part 60.

As illustrated in FIG. 2, the relay board 50 is mounted on the lower surface of a second region 11a2 of the top plate 11a, parallel to the second region 11a2. That is, the mounting surface of the relay board 50 is parallel to the upper and lower surfaces of the second region 11a2 and parallel to the plane including the width direction and the front-rear direction.

### Control Board Part 60

The control board part 60 receives a print data signal from the controller 600 of the printer 1000, and transmits the print data signal to the control board 442 of each of the head mechanisms 40, via the relay board 50. The control board part 60 is disposed inside the second part 12 of the casing 10 (FIG. 2).

A terminal (not illustrated in the drawings) of the control board part 60 projects downward via an opening (not illustrated in the drawings) extending through the bottom plate 12b of the second part 12. The terminal is attached to and detached from a connector (not illustrated in the drawings) of the relay board 50 via an opening (not illustrated in the drawings) extending through the second region 11a2 of the top plate 11a of the first part 11 so that the second part 12 is attached to and detached from the first part 11.

### Flow of Ink

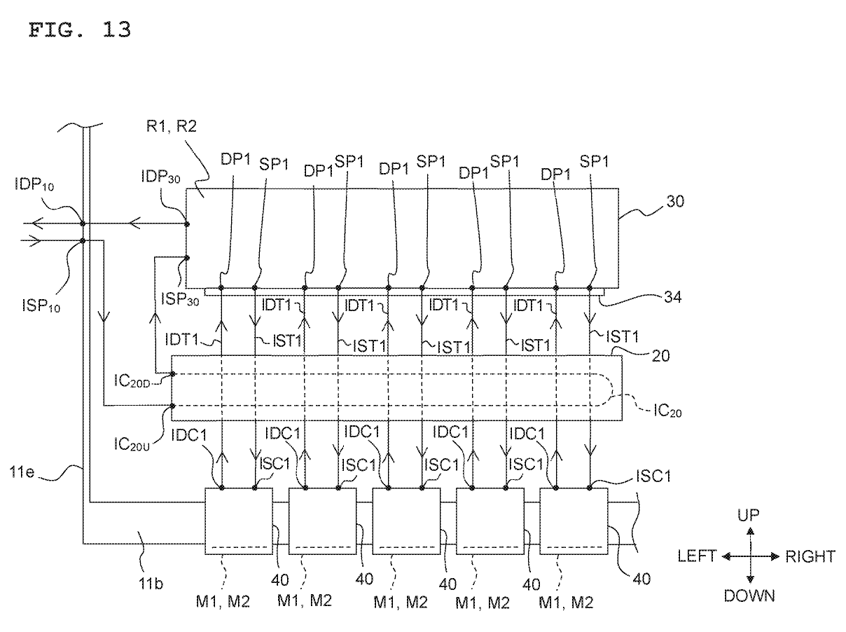

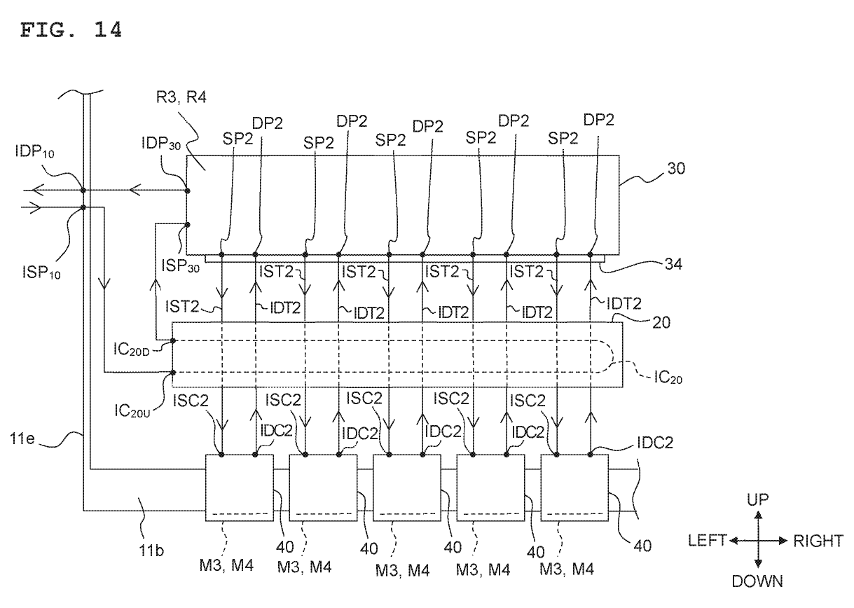

A flow of the ink in the head system 100 will be described, with reference to FIG. 13 and FIG. 14. The head system 100 is capable of causing up to two kinds of inks to flow simultaneously.

As illustrated in FIG. 13, a first ink supplied from the reservoir 500 to the frontward ink supply port ISP₁₀ flows, via the pipe channel, to the upstream end IC_{20U} of the ink channel IC₂₀ of the frontward heating assembly 20. The first ink is then heated in the ink channel IC₂₀, and then the first ink flows out from the downstream end IC_{20D} of the ink channel IC₂₀.

The first ink which has flowed out of the downstream end IC_{20D} of the ink channel IC₂₀ flows into the first reservoir R1 from the ink supply port ISP₃₀ of the sub-tank 30 via the pipe channel. The first ink inside the first reservoir R1 is supplied, via the distribution channel (not illustrated in the drawings) in a lower portion of the sub-tank 30, to the first ink supply port SP1 of each of the ten ink flow port sets S of the bottom plate 33; the ink then flows through the first ink supply tube IST1, and flows into each of the ten head mechanisms 40 from the first ink supply tube connecting part ISC1 of each of the ten head mechanisms 40, via the first ink supply tube IST1.

The first ink which has flowed into each of the head mechanisms 40 flows through the first and second manifold channels M1 and M2 inside each of the head mechanisms 40. The first ink which has not been ejected from the nozzles 3 flows from the first ink discharge tube connecting part IDC1 of each of the head mechanisms 40, via the first ink discharge tube IDT1, into the first ink discharge port DP1 of a corresponding one of the ink flow port sets S, and reaches the second R2. Afterward, the first ink flows out of the frontward ink discharge port IDP₃₀ of the sub-tank 30, reaches the ink discharge port IDP₁₀ of the casing 10 via the pipe channel, and is returned to the reservoir 500.

As illustrated in FIG. 14, second ink which has been supplied from the reservoir 500 to the rearward ink supply port ISP₁₀ flows into the upstream end IC_{20U} of the rearward heating assembly 20 via the pipe channel. After the second ink is heated in the ink channel IC₂₀, the second ink flows out from the downstream end IC_{20D} of the ink channel IC₂₀.

The second ink which has flowed out of the downstream end IC_{20D} of the ink channel IC₂₀ flows into the fourth reservoir R4 from the ink supply port ISP₃₀ of the sub-tank 30, via the pipe channel. The second ink inside the fourth reservoir R4 is supplied to the second ink supply port SP2 of each of the ten ink flow port sets S of the bottom plate 33, via a distribution channel (not illustrated in the drawings) in the lower portion of the sub tank 30. The second ink then flows through the second ink supply tube IST2, and flows into each of the ten head mechanisms 40 from the second ink supply tube connecting part ISC2 of each of the ten head mechanisms 40.

The second ink which has flowed into each of the ten head mechanisms 40 flows through the third and fourth manifold channels M3 and M4 inside each of the ten head mechanisms 40. The second ink, which has not been ejected from the nozzles 3, flows from the second ink discharge tube connecting part IDC2 of each of the ten head mechanisms 40 and into the second ink discharge port DP2 of each of the ink flow port sets S, via the ink discharge tube IDT2, and reaches the third reservoir R3. Afterward, the second ink flows out of the ink discharge port IDP₃₀, reaches the ink discharge port IDP₁₀ of the casing 10 via the pipe channel, and is returned to the reservoir 500.

### Printing Method

The printer 1000 performs formation of an image with respect to the medium PM as follows, with the controller 600 controlling each part of the printer 1000.

The controller 600 controls the pump (not illustrated in the drawings) to supply the inks from the reservoir 500 to the ten head mechanisms 40 of the head system 100. The inks from the reservoir 500 is fed to the ten head mechanisms 40 of the head system 100, along a path illustrated in FIG. 13 and FIG. 14.

In parallel with the above-described supplying of the ink, the controller 600 transmits print data in accordance with an image to be formed to the control board part 60. The control board part 60 transmits the print data to the control board 442 of each of the head mechanisms 40, via the relay board 50 and the flexible circuit board (not illustrated in the drawings). The control board 442 of each of the head mechanisms 40 drives each of the plurality of piezoelectric actuators 432 at an appropriate timing based on the print data, and ejects the ink from the nozzles 3 at an appropriate timing.

The controller 600 alternately performs the ejection of the ink and conveyance of the medium PM along the conveying direction using the pair of conveying rollers 301 and 302 so as to form the image in accordance with the print data on the medium PM.

### Method of Manufacturing Head System 100

The heater module 22 can be attached to the channel part 21 of the heating assembly 20 during the manufacture of the head system 100, as follows.

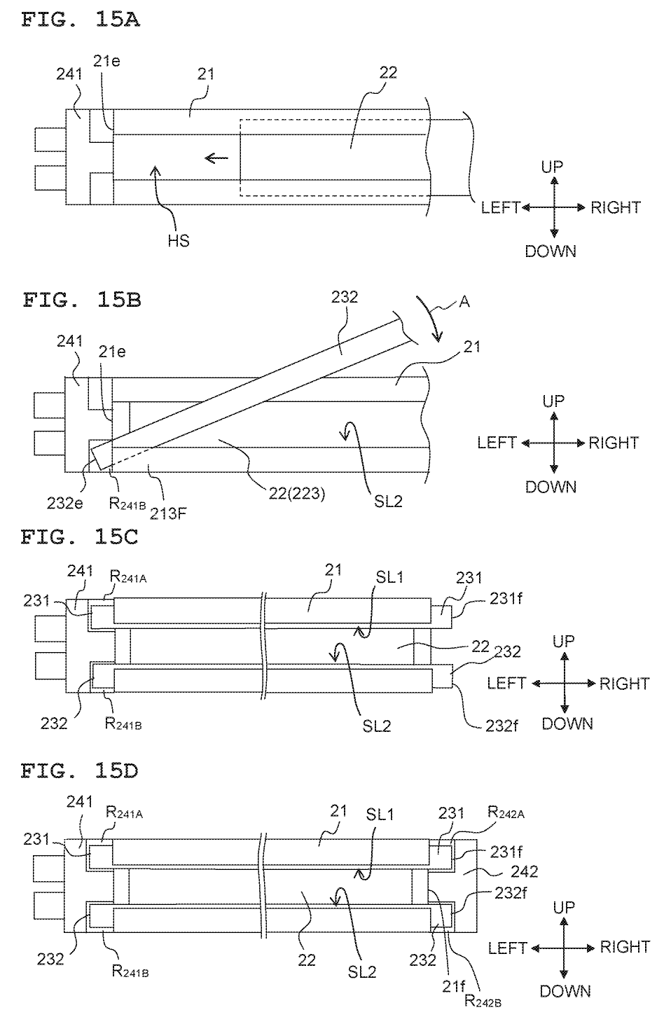

First, as illustrated in FIG. 15A, an operator attaches the block body 241 to the left end portion 21e of the channel part 21. Next, the operator inserts the heater module 22 along the width direction (an example of a "first direction") from the right of the channel part 21 to the inside of the housing space HS. The thickness T₂₂ of the heater module 22 is smaller than the depth D_{HS} of the housing space HS, and the width W₂₂ of the heater module 22 is smaller than the width W_{HS} of the housing space HS. Therefore, the operator is enable to easily insert the heater module 22 into the housing space HS without generating excess friction between the channel part 21 and the heater module 22.

Next, as illustrated in FIG. 15B, the operator inserts the left end portion 232e of the fixing plate 232 up to the recessed portion R_{241B} of the block body 241, via a clearance between the metal plate 223 and the facing portion 213F of the heater module 22. Then, the operator presses the fixing plate 232 downward (an example of a "second direction") at a position in the vicinity of the left end portion 21e of the channel part 21, and fits the fixing plate 232 into the groove SL2 (more specifically, into the space between the metal plate 223 and the facing portion 213F). That is, the operator pushes the fixing plate 232 into a space between the metal plate 223 and the facing portion 213F. The fixing plate 232 which has been pushed into the space presses the metal plate 223 toward the main body portion 211 and presses the heater 221 toward the main body portion 211 via the metal plate 223. The pressing of the fixing plate 232 downward by the operator, i.e., the fitting of the fixing plate 232 into the groove SL2, can be performed, for example, by clamping the upper edge of the fixing plate 232 and the lower edge of the channel part 21 with, for example, pliers.

Next, the operator fits the fixing plate 232 into the groove SL2 again in the same manner as described above, at a position shifted to the right from the position at which the fixing plate 232 has been fitted into the groove SL2. Afterward, the operator fits the fixing plate 232 into the groove SL2 while gradually shifting, to the right, the position at which the operator presses the fixing plate 232 downward. As a result, the fixing plate 232 will be fitted into the groove SL2 while pivoting in a direction indicated by an arrow A in FIG. 15B, and a major portion of the fixing plate 232 will be located in the groove SL2, as illustrated in FIG. 15C.

The operator fits the fixing plate 231 into the groove SL1 in a similar manner as described above regarding the fixing plate 232. As a result, the right end portion 231f of the fixing plate 231 and the right end portion 232f of the fixing plate 232 are in a state of protruding rightward from the channel part 21 (FIG. 15C).

Finally, the operator attaches the block body 242 to the right end portion 21f of the channel part 21. The right end portion 231f of the fixing plate 231 is located inside the recessed portion R_{242A} of the block body 242, and the right end portion 232f of the fixing plate 232 is located inside the recessed portion R_{242B} of the block body 242.

The effect of the head system 100 of the present embodiment is summarized as follows.

In the heating assembly 20 of the head system 100 of the present embodiment, the heater module 22 is fixed relative to the channel part 21 by the fixing plates 231 and 232, which are separate bodies from the heater module 22 and located between the facing portions 212F and 213F of the channel part 21 and the metal plate 223 of the heater module 22. Therefore, the operator performing the operation of assembling the heating assembly 20 is capable of easily disposing the heater module 22 in the housing space HS and fixing the heater module 22 relative to the channel part 21 of the heater module 22. Therefore, according to the head system 100 of the present embodiment, the trouble for the assembly operation of the heating assembly 20 can be reduced, and consequently, the trouble for the assembling operation of the head system 100 can be reduced.

Here, a comparative aspect as follows will be considered. In this comparative aspect, the front surface 223c, of the metal plate 223 being a part of the heater module 22, is brought into contact with the rear surfaces 212Fd and 213Fd of the facing portions 212F and 213F so as to fix the heater module 22 relative to the channel part 21. In this comparative aspect, the metal plate 223 of the heater module 22 located in the housing space HS always contacts the facing portions 212F and 213F. Therefore, the operator performing the assembly operation of the heating assembly 20 needs to insert the heater module 22 into the housing space HS against the frictional force generated between the metal plate 223 and the rear surfaces 212Fd and 213Fd. Further, in this comparative aspect, the operator inserts the heater module 22 into the housing space HS in a state where the heater module 22 (mainly the heat-dissipating sheet 222) is compressed in the thickness direction. Therefore, the operator needs to insert the heater module 22 into the housing space HS, also against a repulsive force due to the compression of the heater module 22. Therefore, the operation of disposing the heater module 22 in the housing space HS is a difficult operation which requires force. Especially, in such a case where the length L₂₁ of the channel part 21 and the length L₂₂ of the heater module 22 are large, an amount of inserting the heater module 22 into the housing space HS becomes large, and thus the operation of disposing the heater module 22 in the housing space HS becomes a more difficult operation which requires more force.

In contrast, according to the heating assembly 20 of the head system 100 of the present embodiment, the operator is capable of easily disposing the heater module 22 into the housing space HS, substantially without any friction generated between the channel part 21 and the heater module 22 and without compressing the heater module 22. Further, the operator is capable of easily fixing the heater module 22, which is disposed in the housing space HS, relative to the channel part 21 by disposing the fixing plates 231 and 232 between the facing portions 212F and 213F of the channel part 21 and the metal plate 223 of the heater module 223.

In the heating assembly 20 of the head system 100 of the present embodiment, the channel part 21 has the holding portion 212 located at the upper edge of the main body portion 211 and the holding portion 213 located at the lower edge of the main body portion 211. Further, the heater module 22 is fixed relative to the channel part 21 with the fixing plate 231 located between the metal plate 223 of the heater module 22 and the facing portion 212F of the holding portion 212, and the fixing plate 232 located between the metal plate 223 of the heater module 22 and the facing portion 213F of the holding portion 213. Accordingly, the heater module 22 can be pressed with respect to the main body portion 211 in a balanced manner in the up-down direction, and the heater 221 can be brought into contact satisfactorily with the main body portion 211.

In the heating assembly 20 of the head system 100 of the present embodiment, the fixing plate 231 and the fixing plate 232 are apart from each other in the up-down direction. Accordingly, the operator is capable of easily pressing the lower edge of the fixing plate 231 when pushing the fixing plate 231 into the groove SL1, without any interference from the fixing plate 232. Similarly, the operator is capable of easily pressing the upper edge of the fixing plate 232 when pressing the fixing plate 232 into the groove SL2, without any interference from the fixing plate 231.

In the heating assembly 20 of the head system 100 of the present embodiment, the width W₂₃₁ of the fixing plate 231 is larger than the depth D_{SL1} of the groove SL1. Accordingly, in a state where the fixing plate 231 is fitted into the groove SL1, the region in the vicinity of the lower edge of the fixing plate 231 is located outside the groove SL1. Therefore, in a case where the fixing plate 231 is fitted into the groove SL1, a tool such as pliers can be brought into contact with the lower edge of the fixing plate 231, until the fitting of the fixing plate 231 is completed, making the assembly operation easier. This is similarly applicable also to the fixing plate 232 and the groove SL2.

In the heating assembly 20 of the head system 100 of the present embodiment, the lengths L₂₃₁ and L₂₃₂ of the fixing plates 231 and 232 are larger than the length L₂₁ of the channel part 21. Accordingly, when the operator fits the fixing plates 231 and 232 into the grooves SL1 and SL2, respectively, the operator is capable of easily perform positioning between the channel part 21 and the fixing plates 231 and 232 in the longer directions of the channel part 21 and the fixing plates 231 and 232.

In the heating assembly 20 of the head system 100 of the present embodiment, in the longer direction of the channel part 21 (the width direction of the head system 100), the fixing plates 231 and 232 are present in the entire area of the region at which the heater 221 is present. Accordingly, the pressing of the heater module 22 with respect to the main body portion 211 can be performed in a balanced manner in the longer direction of the main body portion 211, and the heater 221 can be brought into contact with the main body portion 211 more satisfactorily.

In the heating assembly 20 of the head system 100 of the present embodiment, the block bodies 241 and 242 are attached, respectively, to the both end portions in the longer direction of the channel part 21. The block bodies 241 and 242 are capable of shielding end surfaces in the longer direction of the heater module 22.

In the heating assembly 20 of the head system 100 of the present embodiment, the left end portion 231e and the right end portion 231f of the fixing plate 231 which protrude, respectively, the both sides of the groove SL1 are located inside the recessed portions R_{241A} and R_{242A} of the block bodies 241 and 242, respectively. Similarly, the left end portion 232e and the right end portion 232f of the fixing plate 232 which protrude, respectively, the both sides of the groove SL2 are located inside the recessed portions R_{241B} and R_{242B} of the block bodies 241 and 242, respectively. Accordingly, the positioning of the fixing plates 231 and 232 can be performed by using each of the recessed portions R_{241A} and R_{242A} and recessed portions R_{241B} and R_{242B}. Further, occurrence, for example, of falling off, positional deviation, etc., of the fixing plates 231 and 232 due to unintentional external force applied to the end portions of the fixing plates 231 and 232 protruding from the groove SL1 and groove SL2, respectively, can be reduced.

In the heating assembly 20 of the head system 100 of the present embodiment, the left end portion 231e and the right end portion 231f, of the fixing plate 231, which protrude, respectively, the both sides of the groove SL1 which is open downward are located inside the recessed portions R_{241A} and R_{242A} of the block bodies 241 and 242, respectively. Further, the surfaces defining the recessed portions R_{241A} and R_{242A} include the upward-facing surfaces S_{241A} and S_{242A}. Accordingly, the surfaces S_{241A} and S_{242A} regulate the downward movement of the fixing plate 231, which in turn satisfactorily reduces the falling off of the fixing plate 231 from the groove SL1. Similarly, in the heating assembly 20 of the head system 100 of the present embodiment, the left end portion 232e and the right end portion 232f, of the fixing plate 232, which protrude, respectively, the both sides of the groove SL2 which is open upward are located inside the recessed portions R_{241B} and R_{242B} of the block bodies 241 and 242, respectively. Further, the surfaces defining the recessed portions R_{241B} and R_{242B} include the downward-facing surfaces S_{241B} and S_{242B}. Accordingly, the surfaces S_{241B} and S_{242B} regulate the upward movement of the fixing plate 232, which in turn satisfactorily reduces the falling off of the fixing plate 232 from the groove SL2.

In the heating assembly 20 of the head system 100 of the present embodiment, the heater module 22 includes the heat-dissipating sheet 222 formed of the elastic material. Accordingly, the heat-dissipating sheet 222 is compressed in a case where the fixing plates 231 and 232 press the metal plate 223, and the repulsive force from the compressed heat-dissipating sheet 222 brings the heater 221 into contact with the main body portion 211 satisfactorily, and brings the metal plate 223 into contact with the fixing plates 231 and 232 satisfactorily. Thus, the excess heat can be transferred (released) to the outside more efficiently.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

In the head system 100 of the above-described embodiment, modifications as follows may be used.

In the head system 100 of the above-described embodiment, the fixing plates 231 and 232 are used to fix the heater module 22 relative to the channel part 21. However, the present disclosure is not limited to such aspect.

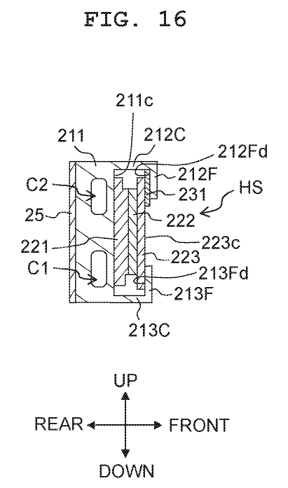

Specifically, for example, the fixing plate 232 may be omitted and the fixing plate 231 (i.e., single fixing plate) may be used to fix the heater module 22 relative to the channel part 21. In this case, as illustrated in FIG. 16, the distance in the front-rear direction between the front surface 211c of the main body portion 211 and the rear surface 213Fd of the facing portion 213F of the holding portion 213 is made smaller than the distance in the front-rear direction between the front surface 211c of the main body portion 211 and the rear surface 212Fd of the facing portion 212F of the holding portion 212. The fixing plate 231 is disposed between the front surface 223c of the metal plate 223 of the heater module 22 and the rear surface 212Fd of the facing portion 212F of the holding portion 212.

In this modification, since the metal plate 223 and the rear surface 213Fd of the facing portion 213F of the holding portion 213 may be brought into contact with each other in a case where the heater module 22 is inserted into the housing space HS, the friction may be generated between the metal plate 223 and the rear surface 213Fd. However, since the contact area between the metal plate 223 and the rear surface 213Fd is small, the operation of disposing the heater module 22 in the housing space HS can be performed easily. Further, also in this modification, the fixing plate 231 presses the heater module 22 toward the main body portion 211, thereby bringing the heater 221 into contact satisfactorily with the main body portion 211.

In the heating assembly 20 of the head system 100 of the above-described embodiment, the holding portions 212 and 213 of the channel part 21 can be configured in various aspects.

Specifically, for example, the rear surface 212Fd, 213Fd of the facing portion 212F, 213F may not be parallel to the front surface 211c of the main body portion 211, or the facing portion 212F, 213F may not be the flat surface. Further, the holding portion 212, 213 need not be located in the entire area in the longer direction of the channel part 21, and may be located merely in a partial region in the longer direction of the channel part 21.

In the heating assembly 20 of the head system 100 of the above-described embodiment, the heater 221 of the heater module 22 may be a rubber heater. The rubber heater is compressed in a case where the fixing plates 231 and 232 are fitted into the groove SL1 and SL2, respectively, and the repulsive force from the compressed rubber heater brings the metal plate 223 into contact satisfactorily with the fixing plates 231 and 232.

In the heating assembly 20 of the head system 100 of the above-described embodiment, the heat-dissipating sheet 222 of the heater module 22 may be omitted.

In the heating assembly 20 of the head system 100 of the above-described embodiment, the heater 221 may not be present at a portion in the longer direction of the heater module 22.

In the heating assembly 20 of the head system 100 of the above-described embodiment, the width W₂₂ of the heater module 22 is smaller than the width W_{HS} of the housing space HS. However, the present disclosure is not limited to this. For example, the width W₂₂ of the heater module 22 may be the same as the width W_{HS} of the housing space HS.

In the heating assembly 20 of the head system 100 of the above-described embodiment, the fixing plates 231 and 232 may be configured in various aspects.

Specifically, for example, the lengths L₂₃₁ and L₂₃₂ of fixing plates 231 and 232 may be any lengths, and may be the same as the length L₂₁ of the channel part 21 or smaller than the length L₂₁ of channel part 21. The widths W₂₃₁ and W₂₃₂ of the fixing plates 231 and 232 may also be any widths, and may be the same as the depths D_{SL1} and D_{SL2} of the grooves SL1 and SL2, or smaller than the depths D_{SL1} and D_{SL2} of the grooves SL1 and SL2. Instead of the fixing plates 231 and 232, a plurality of fixing plates disposed side by side in the longer direction of the channel part 21 may be used.

The fixing plate 231, 232 is not limited to the configuration wherein the front surface 231c, 232c and the rear surface 231d, 232d are parallel to one another. For example, the front surface 231c, 232c and the rear surface 231d, 232d may be inclined with respect to one another as viewed in the longer direction of the fixing plate 231, 232.

In the above-described embodiment, the main body portion 211 is in direct contact with the heater 221, the heater 221 is in direct contact with the heat-dissipating sheet 222, the heat-dissipating sheet 222 is in direct contact with the metal plate 223, the metal plate 223 is in direct contact with the fixing plates 231 and 232, and the fixing plates 231 and 232 are respectively in direct contact with the facing portions 212F and 213F. The present disclosure, however, is not limited to the above-described configuration. Another member (for example, a plate member) may be interposed in at least one of the following locations which are: between the main body portion 211 and the heater 221; between the heater 221 and the heat-dissipating sheet 222; between the heat-dissipating sheet 222 and the metal plate 223; between the metal plate 223 and the fixing plate 231 or 232; and between the fixing plate 231 or 232 and the facing portion 212F or 213F.

In the above-described embodiment, the dimension of each of the channel part 21, the heater module 22, and the fixing plates 231 and 232 may be changed as needed.

In the heating assembly 20 of the head system 100 of the above-described embodiment, the channel part 21 has the long shape. The present disclosure, however, is not limited to such aspect. The effect that the head module 22 can be easily inserted into the housing space HS, which is achieved based on the structure of the heating assembly 20 of the head system 100 of the above-described embodiment, is particularly advantageous in a case where the channel part 21 is of the long shape. However, this effect is also advantageous in a case where the channel part 21 does not have a long shape. Note that in the present disclosure and the present invention, the term "long shape" means that a shape of which dimension in a first direction is X times or more the dimension in a second direction orthogonal to the first direction, and is X times or more the dimension in a third direction orthogonal to the first and second directions. Here, the X" may be 1.1, 1.5, 2, 5, or 10.

The head system 100 of the above-described embodiment includes the ten head mechanisms 40 disposed in the staggered pattern along the width direction. The present disclosure, however, is not limited to this. The number of the head mechanisms 40 included in the head system 100 is any number. In a configuration having at least three head mechanisms 40, the head mechanisms 40 may be disposed in a staggered pattern.

The head system 100 of the above-described embodiment is configured to cause the two kinds of inks to flow simultaneously. The present disclosure, however, is not limited to this. The head system 100 may be configured to cause one kind of ink to flow singly.

The head system 100 of the above-described embodiment is a circulating head system with the structure configured to discharge the ink which has not been ejected in the head mechanism 40 to the outside of the head system 100. The present disclosure, however, is not limited to this. The structure configured to discharge the ink from the head system 100 may be omitted in the head system 100 of the above-described embodiment.

In the foregoing, the embodiment and modifications have been described, with the case of forming an image on a medium PM by ejecting the ink(s) from the head system 100, as an example. The head system 100 may be a liquid ejecting system which ejects any liquid to form an image, and the medium PM on which the image is formed may be, for example, a sheet, cloth, resin, etc. The head system 100 may also be used as a head system of a printer of the serial head type.

The embodiment described in the present specification is in all respects an exemplification, and should not be considered limiting in any sense. For example, the number, configuration, and so on, of the head systems 100 in the printer 1000 may be changed. The number of colors simultaneously printable by the printer 1000 is not limited either, and such a configuration dedicated to single-color printing is also possible. Further, the number, disposition, and so on, of the individual channels iCH may also be appropriately changed. Furthermore, the technical features described in each of the embodiment and modifications can be combined with each other.

As long as the features of the present invention are maintained, the present invention is not limited to the above-described embodiment. Further, any aspect conceivable within the technical ideas of the present invention is also encompassed in the scope of the present invention.

What is claimed is:

1. A liquid ejecting unit comprising:
a head; and
a heating assembly,
wherein the heating assembly includes:
a main body having a channel configured to flow liquid through the channel, the channel being disposed inside the main body, the liquid being liquid to be supplied to the head;
a holder including a facing portion facing the main body in a facing direction and a connecter connecting the main body and the facing portion;
a heater configured to apply heat to the main body;
a main metal plate positioned between the heater and the facing portion in the facing direction; and
a sub-metal plate positioned between the main metal plate and the facing portion in the facing direction, the sub-metal plate pressing the heater toward the main body via the main metal plate.

2. The liquid ejecting unit according to claim 1, wherein:
the main body has a long shape;
the main body and the holder define a groove opening in a shorter direction, of the main body, orthogonal to the facing direction and a longer direction of the main body; and
at least a portion of the sub-metal plate is positioned in the groove.

3. The liquid ejecting unit according to claim 2, wherein:
the holder includes a first holder positioned at a first-side in the shorter direction and a second holder positioned at a second-side, opposite to the first-side, in the shorter direction;
the groove includes:
a first groove defined by the main body and the first holder, the first groove opening toward the second-side in the shorter direction; and
a second groove defined by the main body and the second holder, the second groove opening toward the first-side in the shorter direction; and
the sub-metal plate includes:
a first sub-metal plate positioned in the first groove; and
a second sub-metal plate positioned in the second groove.

4. The liquid ejecting unit according to claim 3, wherein the first sub-metal plate and the second sub-metal plate are apart from each other in the shorter direction.

5. The liquid ejecting unit according to claim 2, wherein a dimension in the shorter direction of the sub-metal plate is greater than a depth in the shorter direction of the groove.

6. The liquid ejecting unit according to claim 2, wherein in the longer direction of the main body, the sub-metal plate is longer than the main body.

7. The liquid ejecting unit according to claim 2, wherein in the longer direction of the main body, the sub-metal plate is present in an entire area of a region in which the heater is present.

8. The liquid ejecting unit according to claim 2, wherein the heating assembly has a block body connected to an end in the longer direction of the main body.

9. The liquid ejecting unit according to claim 8, wherein:
the block body has two openings arranged side by side in the shorter direction of the main body, each of the two openings extending through the block body along the longer direction of the main body; and
the heating assembly has two pipe channels each positioned in a corresponding one of the two openings and each fluidly connected to the channel.

10. The liquid ejecting unit according to claim 8, wherein:
in the longer direction of the main body, the sub-metal plate is longer than the main body;
the block body has a recessed portion; and
an end of the sub-metal plate is positioned in the recessed portion of the block body.

11. The liquid ejecting unit according to claim 10, wherein:
the groove opens toward one side in the shorter direction of the main body; and
a surface defining the recessed portion includes a surface facing opposite to the one side in the shorter direction.

12. The liquid ejecting unit according to claim 1, wherein the heating assembly has a heat-dissipating sheet positioned between the heater and the main metal plate in the facing direction.

13. A method of manufacturing a liquid ejecting unit, the liquid ejecting unit including:
a head; and
a heating assembly,
wherein the heating assembly includes:
a main body having a channel configured to flow liquid through the channel, the channel being disposed inside the main body, the liquid being liquid to be supplied to the head;
a holder including a facing portion facing the main body in a facing direction and a connecter connecting the main body and the facing portion;
a heater configured to apply heat to the main body;
a main metal plate positioned between the heater and the facing portion in the facing direction; and
a sub-metal plate positioned between the main metal plate and the facing portion in the facing direction, the sub-metal plate pressing the heater toward the main body via the main metal plate,
the method comprising:
inserting the heater and the main metal plate into a space between the main body and the facing portion along a first direction; and
fitting the sub-metal plate into a space between the inserted main metal plate and the facing portion along a second direction intersecting the first direction.
